(19) United States
(12) Patent Application Publication
(10) Pub. No.: US 2025/0026318 A1
(43) Pub. Date: Jan. 23, 2025

(54) SYSTEM FOR MECHANICALLY SWAPPING A BATTERY PACK

(71) Applicant: Toyota Research Institute, Inc., Los Altos, CA (US)

(72) Inventors: Abraham Silar Anapolsky, San Mateo, CA (US); Kumudra Minhtin Aung, Mountain View, CA (US); Alexander Russell Green, Redwood City, CA (US); Kazunori Nimura, Novi, MI (US); James Robert White, San Mateo, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/354,313

(22) Filed: Jul. 18, 2023

(51) Int. Cl. B60S 5/06; B60K 1/04; B60L 53/80; H01M 50/244

(52) U.S. Cl. CPC B60S 5/06; B60K 1/04; B60L 53/80; H01M 50/244; H01M 2220/20

(57) ABSTRACT

An electric vehicle (EV) battery pack replacement system includes a replacement pack ramp structure having a replacement pack ramp, a vehicle-mountable battery pack receptacle, and a vehicle-mountable replacement pack coupling system structured to be operable to connect a vehicle to a replacement pack positioned on the ramp during movement of the vehicle over the ramp. Further movement of the vehicle over the ramp after connection to the replacement pack to the vehicle moves the replacement pack up the ramp. The ramp is structured so that movement of the replacement pack up the ramp causes the replacement pack to be positioned in in the receptacle. The system uses continuous motion of the vehicle and the replacement pack coupling system for loading a new battery, obviating the need for robotics or other active or powered infrastructure external to the vehicle.

### TECHNICAL FIELD

The subject matter described herein relates to electric and hybrid-electric vehicles powered at least in part by battery packs and, more particularly, to a system structured to autonomously discharge a depleted battery back and replace the discharged battery pack with a replacement battery pack.

### BACKGROUND

Charging an electric or plug-in hybrid vehicle may be difficult due to the scarcity of charging locations. Also, users may not have sufficient time available to fully (or eve n adequately) recharge the vehicle electric battery pack. An alternative to recharging is swapping out a fresh battery for a depleted battery. However, existing battery pack-swapping installations may rely on robotic facilities which require extensive capital and infra structure, lack speed, and require a power source.

### SUMMARY

In one aspect of the embodiments described herein, an electric vehicle (EV) battery pack replacement system is provided. The system includes a replacement pack ramp, a vehicle-mountable battery pack receptacle, and a vehicle-mountable replacement pack coupling system structured to be operable to connect a vehicle to a replacement pack positioned on the ramp during movement of the vehicle over the ramp, so that further movement of the vehicle over the ramp after connection to the replacement pack moves the replacement pack up the ramp, the ramp being structured so that movement of the replacement pack up the ramp causes the replacement pack to be positioned in in the receptacle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is a block schematic diagram of a vehicle 21 incorporating elements configured to operate as part of an electric vehicle (EV) battery pack replacement system 20 in accordance with an embodiment described herein.

FIG. 2A is a schematic side cross-sectional view showing elements of an electric vehicle (EV) battery pack replacement system in accordance with an embodiment described herein.

FIG. 2B is a schematic plan view of the elements of the battery pack replacement system shown in FIG. 2A.

FIG. 3 is a magnified view of a portion of the view shown in FIG. 2A, showing a deployed hook of the replacement pack coupling system engaging a complementary feature on the replacement battery pack to pull the replacement pack up the replacement pack ramp as the vehicle moves forward along tracks of the battery pack replacement system.

FIGS. 4 and 5 are views similar to the view of FIG. 3, showing the replacement battery pack gradually being drawn into the vehicle battery pack receptacle as the vehicle moves forward along tracks of the battery pack replacement system.

FIG. 6 is a view similar to the views of FIGS. 4 and 5, showing the replacement battery pack finally positioned within the vehicle battery pack receptacle.

FIG. 7 is a schematic side cross-sectional view showing elements of an electric vehicle battery pack replacement system in accordance with an alternative embodiment described herein.

FIG. 8 is a flow diagram illustrating operation of an electric vehicle battery pack replacement system in accordance with an embodiment described herein.

### DETAILED DESCRIPTION

Embodiments described herein relate to an electric vehicle (EV) battery pack replacement system. The system includes a replacement pack ramp structure including a replacement pack ramp, a vehicle-mountable battery pack receptacle, and a vehicle-mountable replacement pack coupling system structured to be operable to connect a vehicle to a replacement pack positioned on the ramp during movement of the vehicle over the ramp. Further movement of the vehicle over the ramp after connection to the replacement pack to the vehicle moves the replacement pack up the ramp. The ramp is structured so that movement of the replacement pack up the ramp causes the replacement pack to be positioned in in the receptacle. The system uses continuous motion of the vehicle and the replacement pack coupling system for loading a new battery, obviating the need for robotics or other active or powered infrastructure external to the vehicle.

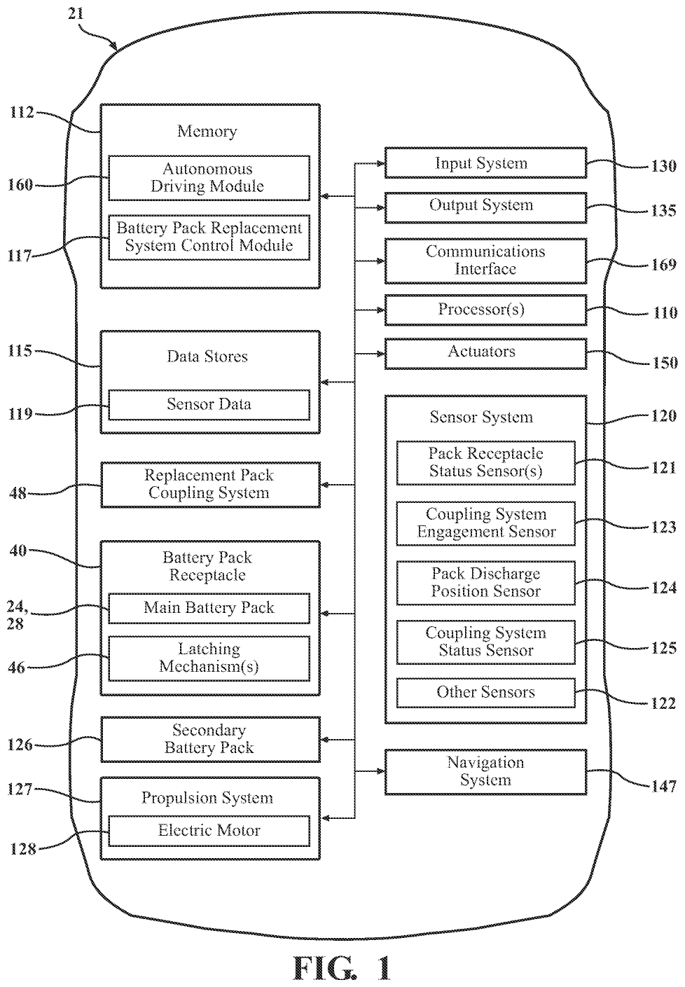

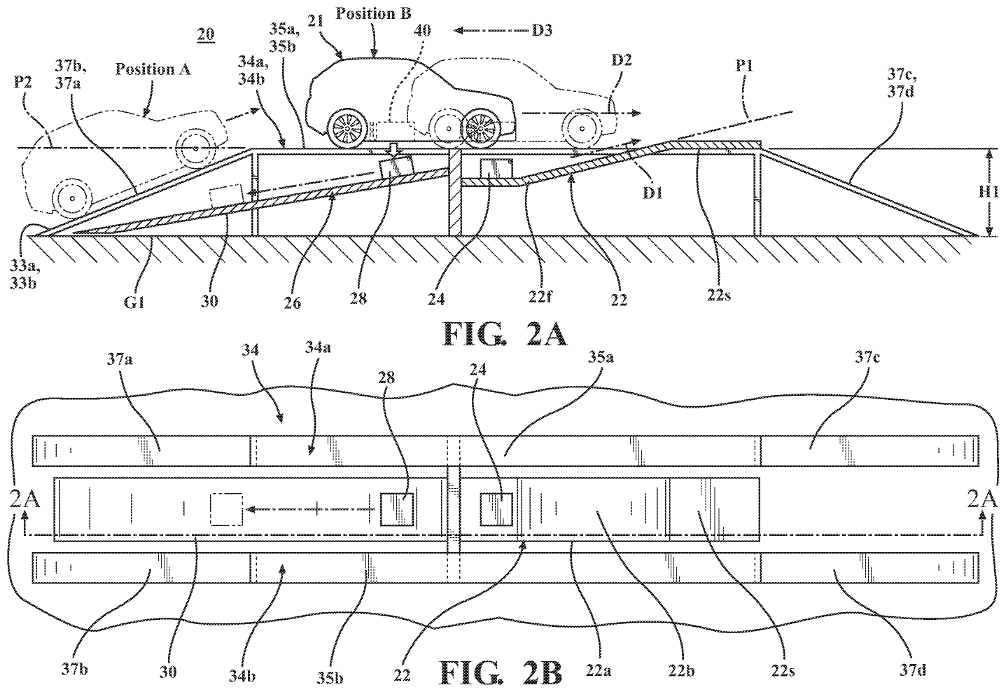

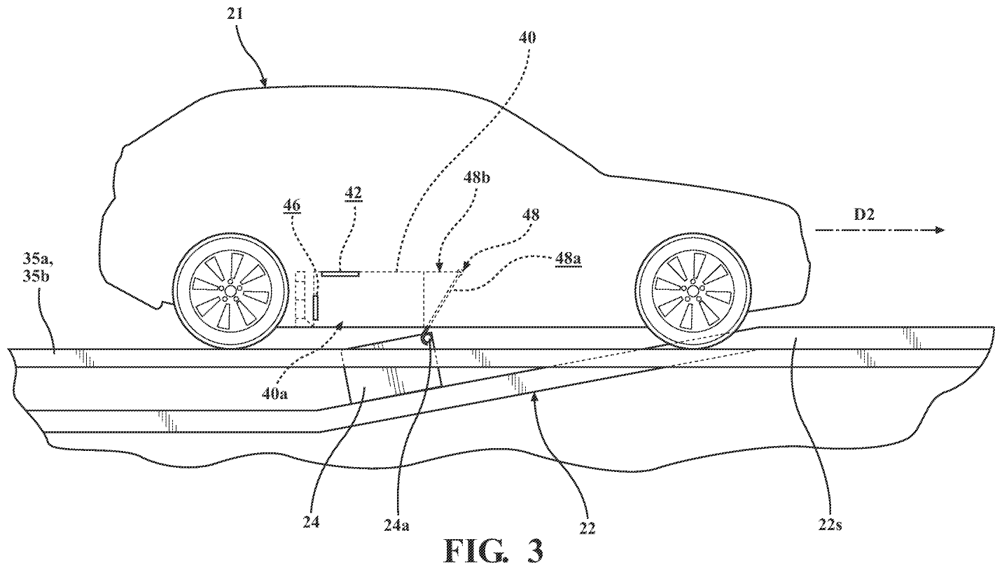

FIG. 1 is a block schematic diagram of a vehicle 21 incorporating elements configured to operate as part of an electric vehicle (EV) battery pack replacement system 20 in accordance with an embodiment described herein. FIG. 2A is a schematic side cross-sectional view showing elements of an electric vehicle (EV) battery pack replacement system 20 in accordance with an embodiment described herein. The system may enable automated replacement of a depleted EV battery pack in the vehicle 21 with a replacement battery pack 24, while the vehicle 21 is in forward motion. FIG. 2B is a schematic plan view of the elements of the battery pack replacement system 20 shown in FIG. 2A.

In one or more arrangements, the battery pack replacement system 20 may include a replacement pack ramp 22. In FIG. 2A, the ramp 22 is shown resting on a ground surface G1. As used herein, a “ramp” is a structure defining a surface having a first, relatively lower end (i.e., an end positioned relatively closer to a ground surface on which the ramp is positioned) and a second, relatively higher end (i.e., an end positioned relatively farther from the ground surface) opposite the first end. The ramp may be structured to enable an elevation of an object above the ground surface to be increased (or decreased) by traveling along a surface of the ramp in a direction from the first end toward the second end. For example, the ramp 22 may be structured and supported so as to rise or ascend from ramp first end 22f to ramp second end 22s, proceeding in a direction D2 of forward travel of the vehicle 21 along the battery pack replacement system 20. A ramp as described herein may include rolling elements. “Rolling elements” may include any elements (e.g., cylindrical rollers, ball bearings, etc.) supportable on the ramp frame 22a and structured to facilitate low-friction movement of depleted and replacement battery packs along respective ramps. For example, the replacement pack ramp 22 may include a frame 22a and a plurality of rolling elements 22b supported by the frame 22a so as to define a movement plane P1 having a first slope (i.e., a change in vertical distance occurring over a given horizontal distance). The movement plane P1 may extend along (and be defined by) upper surfaces of the rolling elements 22b along which the replacement battery pack 24 moves as it proceeds up the ramp 22 in direction D1.

As seen in FIG. 2A, the replacement pack ramp 22 may be structured so that its second end 22s is positioned vertically above a level of first and second tracks 34a, 34b of a vehicle support structure 34 (described in greater detail below) when these elements of the battery pack replacement system 20 are supported on the ground surface G1. Tracks 34a and 34b of the vehicle support structure 34 may be spaced apart to accommodate vehicle track widths of vehicles within a specific range.

In one or more arrangements, the battery pack replacement system 20 may include a depleted battery pack discharge portion (generally designated 26) structured to receive a depleted battery pack 28 released from the vehicle 21. The depleted battery pack discharge portion 26 may be positioned spaced apart from the replacement pack ramp 22 in a direction D3 opposite a direction of travel D2 of the vehicle 21 from the battery pack discharge portion 26 toward the replacement pack ramp 22. As used herein, the terms “depleted battery pack” and “depleted pack” are understood to refer to any battery pack that is to be discharged from the vehicle 21 and swapped out for a replacement pack, regardless of the charge level or available power level of the pack to be replaced.

Referring to FIGS. 2A-2B, in one or more arrangements, the battery pack discharge portion 26 includes a discharge ramp 30 structured to slope downwardly from a location where the depleted pack 28 is received from the vehicle 21. As described herein, the depleted pack 28 may be automatically discharged from the vehicle 21 to drop onto the discharge ramp 30. The depleted pack 28 may then roll down the discharge ramp 30 along associated rolling elements to the end of the discharge ramp 30, from where it may drop onto (or be loaded onto) a cart (not shown) or other battery transport device for transport to a recharging station (not shown).

Referring to FIGS. 2A and 2B, in one or more arrangements, the battery pack replacement system 20 may include a vehicle support structure 34 having first track 34a extending along a first side of the replacement pack ramp 22, and a second track 34b extending along a second side of the replacement pack ramp 22 opposite the first side and parallel to the first track 34a.

The vehicle support structure first track 34a may include a first leveled portion 35a extending along the first side of the replacement pack ramp 22 and adjacent the ramp second end 22s. In addition, the second track 34b may include a second leveled portion 35b extending along the second side of the replacement pack ramp 22 and adjacent the ramp second end 22s. A “leveled portion” of a vehicle support structure track is a portion of the track which extends parallel to a ground surface supporting the track. Thus, in a case where the ground surface G1 may be considered horizontal, the “leveled portion” of a vehicle support structure track may also be considered horizontal. Also, the first leveled portion 35a and the second leveled portion 35b may be positioned at the same level or height H1 above the ground surface G1 (i.e., the first and second leveled portions 35a. 35b may be coplanar). In combination, the first and second leveled portions 35a. 35b may define a plane P2 on which the vehicle wheels rest and upon which the vehicle 21 is supported when all driven wheels of the vehicle 21 are positioned on the first and second leveled portions 35a, 35b.

In systems where the vehicle 21 is elevated above the ground surface G1 during battery pack discharge and replacement, the first track 34a may include a first vehicle ramp 37a structured to be connectible to the first leveled portion 35a. In addition, the second track 34b may include a second vehicle ramp 37b structured to be connectible to the second leveled portion 35b and positionable opposite the first vehicle ramp 37a. The vehicle ramps 37a and 37b may enable the vehicle 21 to ascend above the ground surface G1 to the associated leveled portions 35a and 35b.

Also, the first track 34a may include a third vehicle ramp 37c structured to be connectible to the first leveled portion 35a, and the second track 34b may include a fourth vehicle ramp 37d structured to be connectible to the second leveled portion 35b and positionable opposite the third vehicle ramp 37c. The vehicle ramps 37c and 37d may enable the vehicle 21 to descend from the leveled portions 35a. 35b to the ground surface G1. The various vehicle ramps 37a, 37b, 37c, 37d and the leveled portions 35a, 35b of the vehicle support structure 34 may be supported by trusses, a collection of appropriately positioned posts, or any other suitable structure(s) or combination of structures.

In particular arrangements, the vehicle support structure 34 and any ramps, tracks, and other associated structures designed to support all or part of the vehicle 21 during the battery pack replacement process may be integrated or assembled into a unitary, self-contained structure that is transportable (for example, by attachment of wheels thereto or by loading the structure onto a trailer) and positionable as a whole at a desired location for use in vehicle battery pack replacement operations as described herein.

FIG. 1 shows a block schematic diagram of a vehicle 21 incorporating various elements configured to operate as part of the electric vehicle (EV) battery pack replacement system 20. As used herein, a “vehicle” is any form of motorized transport (such as a parallel hybrid electric vehicle or a fully-electric vehicle) partially or entirely powered by an electric battery pack that may be discharged and replaced in a manner described herein.

The vehicle 21 also includes various elements. It will be understood that in various embodiments it may not be necessary for the vehicle 21 to have all of the elements shown in FIG. 1. The vehicle 21 can have any combination of the various elements shown in FIG. 1. Further, the vehicle 21 can have additional elements to those shown in FIG. 1. In some arrangements, the vehicle 21 may be implemented without one or more of the elements shown in FIG. 1. While the various elements are shown as being located within the vehicle 21 in FIG. 1, it will be understood that one or more of these elements can be located external to the vehicle 21.

Some of the possible elements of the vehicle 21 are shown in FIG. 1 and will be described with reference thereto. Additionally, it will be appreciated that for simplicity and clarity of illustration, where appropriate, reference numerals may have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In some instances, the vehicle 21 may be configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 21 can be a conventional vehicle that is configured to operate in only a manual mode.

In one or more embodiments, the vehicle 21 is an autonomous vehicle. As used herein, “autonomous vehicle” refers to a vehicle that can operate in an autonomous mode. “Autonomous mode” refers to navigating and/or maneuvering the vehicle 21 along a travel route using one or more computing systems to control the vehicle 21 with minimal or no input from a human driver. In one or more embodiments, the vehicle 21 is highly automated or completely automated. In one or more arrangements, the vehicle 21 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 21 along the travel route. In a particular example, the vehicle 21 may be configured to autonomously drive along the electric vehicle (EV) battery pack replacement system 20 to implement autonomous replacement of a depleted battery pack.

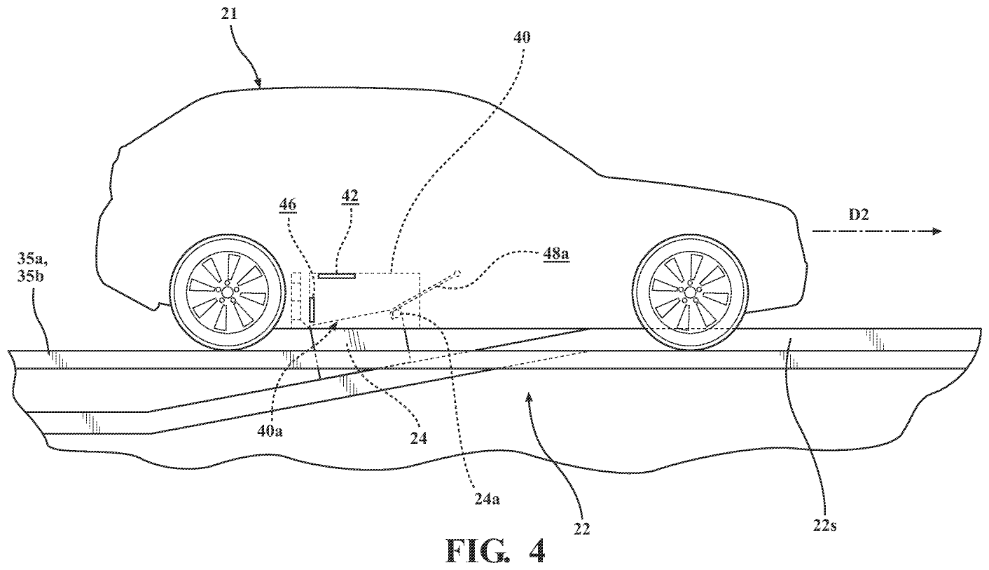

Referring to FIGS. 2A-3, in one or more arrangements, the vehicle 21 may include a vehicle-mountable battery pack receptacle 40 structured to receive and retain a battery pack (e.g., pack 28 or pack 24) therein, for use in powering the vehicle 21 during normal vehicle operations. The battery pack mounted in receptacle 40 may be a main battery pack or power source for a fully-electric vehicle. The receptacle 40 may have an opening 40a accessible from an underside of the vehicle 21 so that a depleted battery pack 28 can be released from the receptacle 40 responsive to a release or discharge command, and so that a replacement battery pack 24 can be inserted into the receptacle through the opening.

The battery pack receptacle 40 may include at least one battery pack power contact 42 mounted along a wall or roof of the receptacle. The battery pack power contact(s) 42 may be structured to physically contact a complementary contact (not shown) positioned on the battery pack to enable power transfer from the battery pack to the vehicle 21 when the battery pack is positioned inside the receptacle 40. In particular arrangements, the receptacle 40 may include multiple battery pack power contacts provided for physically contacting multiple associated complementary contacts positioned on the battery pack.

For purposes described herein, in particular arrangements, a battery pack is considered to be “positioned” inside the receptacle 40 when the battery pack is located such that the receptacle power contact(s) 42 are in electrical communication with associated power contact(s) on the battery pack so as to enable power transfer from the battery pack to the remainder of the vehicle, and also when the battery pack is in a location where actuation of the battery pack receptacle latching mechanism(s) 46 (described below) will secure the battery pack inside the receptacle 40 for normal use. The battery pack power contact(s) may be any type(s) of contacts suitable for transferring power from the battery pack to the remainder of the vehicle 21. and also any type(s) of contacts structured to electrically engage the complementary receptacle power contacts 42 by simply inserting and positioning the battery pack inside the receptacle 40. Examples of known electrical contact or connector systems usable for the purposes described herein include various spring-loaded contact systems and various sliding contact systems.

The battery pack receptacle 40 may include at least one latching mechanism 46 actuatable to a latched configuration structured to engage a battery pack when the pack is positioned inside the receptacle 40, to secure the battery pack inside the receptacle. In this case, “engage” may refer to any direct physical contact or indirect contact between the battery pack and another element of the vehicle 21 or the battery pack replacement system 20. In particular arrangements, the latching mechanism(s) 46 may be structured so that the mechanism(s) are only actuatable to the latched configuration when the mechanism(s) are securing a battery in the receptacle. The latching mechanism(s) 46 may also be actuatable to an unlatched configuration disengaged from the battery pack, to enable the battery pack to drop out of the receptacle 40. In one or more arrangements, the latching mechanism(s) 46 may be structured to be actuatable to any of the latched configuration and the unlatched configuration responsive to control commands generated by a battery pack replacement system control module 117 as described herein.

Referring to FIG. 3, the vehicle 21 may include a vehicle-mountable replacement pack coupling system (generally designated 48) structured to be operable to connect the vehicle 21 to a replacement battery pack 24 positioned on the replacement pack ramp 22 during movement of the vehicle 21 over the replacement pack ramp 22 in a manner such that further movement of the vehicle over the ramp 22 after connection of the vehicle 21 to the replacement pack 24 moves the pack 24 up the ramp and in to the receptacle 40.

In one or more arrangements, the replacement pack coupling system 48 includes a hook 48a structured to engage a complementary feature 24a on the replacement pack 24 to connect the vehicle 21 to the replacement pack. In addition, the replacement pack coupling system 48 may include a hook retention mechanism 48b structured to be actuatable to deploy the hook 48a to an active configuration (shown in FIG. 3) for connecting the replacement pack 24 to the vehicle 21, and structured to be actuatable to secure the hook 48a in an inactive or stowed configuration when not in use. In the stowed configuration, the hook 48a may be retained in an underside of the vehicle 21 in a position designed to prevent contact with any battery pack close to the vehicle. Thus, the hook 48a may engage the replacement battery pack 24 only when the hook 48a is deployed. In one or more arrangements, the replacement pack coupling system 48 may be actuatable to the deployed configuration responsive to control command(s) generated by a battery pack replacement system control module 117 as described herein.

Referring to FIG. 1, the vehicle 21 can include one or more processors 110. In one or more arrangements, the processor(s) 110 can be a main processor(s) of the vehicle 21. For instance, the processor(s) 110 can be an electronic control unit (ECU). The vehicle 21 can include one or more data stores 115 for storing one or more types of data. The data store(s) 115 can include volatile and/or non-volatile memory. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 can be a component of the processor(s) 110, or the data store(s) 115 can be operably connected to the processor(s) 110 for use thereby. The term “operably connected,” as used throughout this description, can include direct or indirect connections, including connections without direct physical contact.

The one or more data store(s) 115 can include sensor data 119. In this context, “sensor data” means any information about the sensors that the vehicle 21 is equipped with, including the capabilities and other information about such sensors. As will be explained below, the vehicle 21 can include the sensor system 120. The sensor data 119 can include information on one or more sensors of the sensor system 120.

As noted above, the vehicle 21 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process. In arrangements in which the sensor system 120 includes a plurality of sensors, the sensors can work independently from each other. Alternatively, two or more of the sensors can work in combination with each other. In such case, the two or more sensors can form a sensor network. The sensor system 120 and/or the one or more sensors can be operably connected to the processor(s) 110, the data store(s) 115, and/or other element(s) of the vehicle 21 (including any of the elements shown in FIG. 1).

The sensor system 120 can include any sensor(s) suitable for performing (and/or required to perform) any of the data acquisition and/or vehicle control operations contemplated herein. Various examples of different types of sensors will be described herein. However, it will be understood that the sensors of the sensor system 120 are not limited to the particular sensors described.

Sensors of sensor system 120 may be communicably coupled to the various systems and components of the vehicle 21. The sensors may also be operably connected to the vehicle wireless communications interface 169 for transmission of information to a cloud or other storage facility or for vehicle-to-vehicle (V2V) or vehicle-to-everything (V2X) communications. The sensors may also be operably connected to other vehicle systems and components, such as data stores 115 and processor(s) 110, for storage and processing of sensor data. Sensor system 120 may, for example, include sensors configured to detect the current state or status of vehicle systems and components and to generate indications (for example, using trouble codes) possible malfunctions of vehicle systems and components.

The sensor system 120 can include one or more sensors configured to detect, determine, and/or sense information about the vehicle 21 itself. The sensor system 120 may include one or more sensors configured to detect conditions and/or events inside the vehicle interior or occupant compartment. In one or more arrangements, the sensor system 120 can include sensor(s) configured to detect and/or sense position and orientation changes of the vehicle 21, such as, for example, based on inertial acceleration. In one or more arrangements, the sensor system 120 can include one or more accelerometers, one or more gyroscopes, an inertial measurement unit (IMU), a dead-reckoning system, a global navigation satellite system (GNSS), a global positioning system (GPS), a navigation system, and/or other suitable sensors. Sensor(s) of the sensor system 120 can be configured to detect, and/or sense one or more characteristics of the vehicle 21, such as the current geographical location of the vehicle. In one or more arrangements, the sensor system 120 can include a speedometer to determine a current speed and acceleration/deceleration of the vehicle 21. The sensor system 120 may include vehicle directional sensors (not shown) configured to determine a current heading of the vehicle or direction in which the vehicle is pointed. The sensor system 120 may include temperature sensor(s), including temperature sensor(s) configured to measure temperature(s) of vehicle elements such as a battery pack mounted in the battery pack receptacle 40. The sensor system 120 may include may include one or more system component status sensors, including sensor(s) configured to measure and track a state of charge (SOC) of a battery pack positioned in the battery pack receptacle 40.

The sensor system 120 may also include a sensor (such as a proximity sensor) usable for determining if a hook 48a of the replacement pack coupling system 48 has deployed responsive to a deployment command. In one or more arrangements, the sensor system 120 may include a vehicle-mountable coupling system engagement sensor 123 configured to determine if a replacement pack coupling system is engaged with a replacement battery pack so that the coupling system can pull the replacement pack up the ramp 22. In particular arrangements, the sensor 123 may be a force sensor configured to measure a force exerted on the replacement pack coupling system when the replacement pack 24 is being pulled up the ramp 22.

In one or more arrangements, the sensor system 120 may include one or more battery pack receptacle status sensor(s) (generally designated 121) configured to detect when a battery pack is positioned inside the battery pack receptacle 40. The battery pack receptacle status sensor(s) 121 may be configured to generate an alert or other signal indicating when a battery pack is determined to be (and/or is determined not to be) positioned inside the receptacle 40. For example, a proximity sensor (not shown) may be used to determine whether or not a battery pack is present inside the receptacle 40. The battery pack receptacle status sensor(s) 121 may include one or more latch status sensor(s) configured for determining a latched configuration and/or an unlatched configuration of the latching mechanism(s). In particular arrangements, the sensor system 120 may also include a battery power sensor configured for determining whether or not power is being drawn from a battery pack residing in (or supposedly residing in) in the receptacle. Other types sensors may also be used to determine if a battery pack is positioned inside the receptacle.

Other sensors of the sensor system 120 may be configured to acquire data of at least a portion of the external environment of the vehicle 21 (e.g., nearby objects). For example, environment sensors such as radar, LIDAR, camera(s), and/or other sensors may be incorporated into the vehicle 21 to monitor features of the environment in close proximity to the vehicle 21. For example, one or more of sensors may be configured to serve as a pack-discharge position sensor 124 configured to determine when the vehicle 21 is in a position above the ramp 22 suitable for releasing a depleted battery pack 28 from the receptacle 40. Each of the sensors described herein may be any type of sensor suitable for the purposes described.

For powering the vehicle during the process of replacing depleted battery pack 28 with replacement battery pack 24, a secondary battery pack 126 may be provided. The secondary battery pack 126 may be engaged for powering the vehicle prior to discharge of the depleted battery pack 28 onto the depleted battery pack discharge portion ramp 22.

The vehicle 21 can include a vehicle wireless communications interface 169 configured to enable and/or facilitate communication between the components and systems of the vehicle and entities (such as cloud facilities, cellular and other mobile communications devices, other vehicles, remote servers, pedestrians, etc.) exterior of the vehicle. Wireless communications interface 169 may be configured to facilitate, establish, maintain, and end wireless V2V and V2X communications with any extra-vehicular entity, for example other connectibly-configured vehicles and connected vehicles, pedestrians, servers and entities located in the cloud, edge servers, and other information sources and entities. Information such as sensor data, traffic information, road condition information, weather information, and other types of information may be transmitted and received via the communications interface 169. If required, wireless communications interface 169 may incorporate or be in communication with any network interfaces needed to communicate with any extra-vehicular entities and/or networks.

The vehicle 21 can include an input system 130. An “input system” includes any device, component, system, element or arrangement or groups thereof that enable information/data to be entered into a machine. For example, the input system 130 may include a keypad, a touch screen or other interactive display, a voice-recognition system and/or any other device or system which facilitates communications between a user and the vehicle. The input system 130 can receive an input from a vehicle occupant (e.g., a driver or a passenger) or a user located remotely from the vehicle 21. The vehicle 21 can also include an output system 135. An “output system” includes any device, component, or arrangement or groups thereof that enable information/data to be presented to a vehicle occupant (e.g., a driver, a vehicle passenger, etc.) or a remote user.

The vehicle 21 can include one or more conventional vehicle systems, such as a propulsion system 127, a braking system (not shown), a steering system (not shown), a throttle system (not shown), a suspension system (not shown), a transmission system (not shown), and a navigation system 147. Each of these systems can include one or more devices, components, and/or a combination thereof, now known or later developed. For example, the propulsion system 127 may include an electric motor 128 and one or more electric battery packs received in battery pack receptacle 40 for powering the electric motor. The electric motor 128 may be operably connected to the transmission system so that the motor may provide power to the transmission. The propulsion system 127 may include hardware and/or software elements enabling the electric motor to operate as a generator under certain conditions, to charge the battery pack. The propulsion system 127 may also include other elements. Elements of the propulsion system may be operably connected to any of the modules described herein and/or vehicle systems and components configured to control (or assist in controlling) operations of the propulsion system.

The vehicle 21 may include a navigation system 147 including one or more devices, applications, and/or combinations thereof, now known or later developed, configured to determine the geographic location of the vehicle 21 and/or to determine a travel route for the vehicle 21. The navigation system 147 can include one or more mapping applications to determine a travel route for the vehicle 21. The navigation system 147 can include a global positioning system, a local positioning system or a geolocation system. The navigation system 147 may be configured to track the path of a vehicle along a travel route. The navigation system 147 may be configured to operate in conjunction with the autonomous driving module 160 to guide the vehicle along a travel route selected by a user or along the first and second tracks 34a. 34b of a vehicle support structure 34 as described here for replacement of a depleted battery pack 28 in the receptacle 40.

The vehicle 21 can include one or more actuators 150. The actuator(s) 150 can be any element or combination of elements operable to modify, adjust and/or alter one or more of the vehicle systems 140 or components thereof to responsive to receiving signals or other inputs from the processor(s) 110, any of the modules stored in memory 112, and/or any other vehicle components or systems. Any suitable actuator can be used. For instance, the one or more actuators 150 can include motors, pneumatic actuators, hydraulic pistons, relays, solenoids, and/or piezoelectric actuators, just to name a few possibilities. An example of an actuator that may be incorporated in to the vehicle include actuator(s) configured for releasing a hook 48a of the replacement pack coupling system 48 for deployment responsive to a control command from the battery pack replacement system control module 117, to engage a replacement battery pack 24 for pulling the pack up the ramp 22. Another example of an actuator is an actuator(s) configured to release and engage associated battery pack receptacle latching mechanism(s) 46 to release and secure a battery pack in the receptacle 40 as needed, responsive to control commands received from the battery pack replacement system control module 117.

In embodiments described herein, a memory 112 may store an autonomous driving module 160 and a battery pack replacement system control module 117. The memory 112 is a random-access memory (RAM), read-only memory (ROM), a hard-disk drive, a flash memory, or other suitable memory for storing the modules 160 and 117. The modules 160 and 117 are, for example, computer-readable instructions that when executed by the processor 110, cause the processor(s) 110 to perform the various functions disclosed herein. Additional modules (not shown) may also be stored in memory 112.

The vehicle 21 can include one or more modules, at least some of which are described herein. The modules can be implemented as computer-readable program code that, when executed by processor(s) 110, implement one or more of the various processes described herein. One or more of the modules can be a component of the processor(s) 110, or one or more of the modules can be executed on and/or distributed among other processing systems to which the processor(s) 110 is operably connected. The modules can include instructions (e.g., program logic) executable by one or more processor(s) 110. Alternatively, or in addition, one or more of data store(s) 115 or another portion of the vehicle 21 may contain such instructions.

Generally, a module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 21 can include one or more autonomous driving modules 160. The autonomous driving module(s) 160 can include computer-readable instructions that when executed by the processor(s) 110 cause the processor(s) to perform and/or control certain autonomous driving commands and operations. For example, the autonomous driving module(s) 160 can be configured to receive data from the sensor system 120 and/or any other type of system capable of capturing information relating to the vehicle 21 and/or the external environment of the vehicle 21. The autonomous driving module(s) 160 can determine position and velocity of the vehicle 21. The autonomous driving module(s) 160 can determine the location of obstacles, obstacles, or other environmental features including traffic signs, trees, shrubs, neighboring vehicles, pedestrians, etc., based on sensor data. The autonomous driving module(s) 160 can be configured to receive, and/or determine location information for obstacles within the external environment of the vehicle 21 for use by the processor(s) 110, and/or one or more of the modules described herein to estimate position and orientation of the vehicle 21, vehicle position in global coordinates based on signals from a plurality of satellites, or any other data and/or signals that could be used to determine the current state of the vehicle 21 or determine the position of the vehicle 21 with respect to its environment for use in either creating a map or determining the position of the vehicle 21 in respect to map data.

The autonomous driving module(s) 160 can be configured to determine travel path(s), current autonomous driving maneuvers for the vehicle 21, future autonomous driving maneuvers and/or modifications to current autonomous driving maneuvers based on data acquired by the sensor system 120 and/or information received from a navigation system, such as navigation system 147. “Driving maneuver” means one or more actions that affect the movement of a vehicle. Examples of driving maneuvers include: accelerating, decelerating, braking, turning, moving in a lateral direction of the vehicle 21, changing travel lanes, merging into a travel lane, and/or reversing, just to name a few possibilities. The autonomous driving module(s) 160 can be configured can be configured to implement determined driving maneuvers. The autonomous driving module(s) 160 can cause, directly or indirectly, such autonomous driving maneuvers to be implemented. As used herein, “cause” or “causing” means to make, force, compel, direct, command, instruct, and/or enable an event or action to occur or at least be in a state where such event or action may occur, either in a direct or indirect manner.

The autonomous driving module(s) 160 can be configured to execute various vehicle functions and/or to transmit data to, receive data from, interact with, and/or control the vehicle 21 or one or more vehicle systems. The autonomous driving module(s) 160 may be configured to autonomously control the vehicle 21 so as to drive the vehicle along a travel route, from an initial or start location to a destination. The autonomous driving module(s) 160 can be configured to control operation of the vehicle while driving along the battery pack replacement system 20. For example, the vehicle propulsion system may be controlled to propel the vehicle along the battery pack replacement system 20 at a constant speed unless modified responsive to sensor inputs or control commands. In particular arrangements, the autonomous driving module(s) 160 can be configured to implement an “autonomous battery replacement mode” for controlling operation of the vehicle 21 to achieve autonomous battery pack replacement. The “autonomous battery replacement mode” may be selectable by a user (via input system 130, for example) intending to acquire a replacement battery pack using an embodiment of the battery pack replacement system.

The vehicle 21 can include a battery pack replacement system control module 117. The battery pack replacement system control module 117 may include computer-readable instructions that when executed by the processor(s) cause the processor(s) to perform and/or control certain battery pack replacement-related vehicle commands and operations. The battery pack replacement system control module 117 may be configured to process and/or interpret data and other information received from sensors of sensor system 120, for purposes of performing the battery pack replacement system operations and functions described herein. The battery pack replacement system control module 117 may also be configured to generate any of a variety of alerts indication that one or more operations of the battery pack replacement function have failed or have not been performed (or appear to have failed or not been performed).

For example, the battery pack replacement system control module 117 may be configured to determine (from sensor and/or other information) that at least one receptacle latching mechanism 46 is in one of an unlatched configuration and a latched configuration when it should be in the other of the unlatched configuration and the latched configuration. The battery pack replacement system control module 117 may also be configured to generate an alert indicating that the at least one latching mechanism 46 is in an incorrect configuration.

The battery pack replacement system control module 117 may be configured to generate a control command directing receptacle latching mechanism(s) 46 to actuate to associated unlatched configuration(s) responsive to an indication from a sensor that the vehicle 21 is in a position suitable for releasing a depleted battery pack 28 from the receptacle 40. The battery pack replacement system control module 117 may also be configured to generate a control command directing receptacle latching mechanism(s) 46 to actuate to associated latched configuration(s) responsive to an indication from a sensor that a replacement battery pack 24 has been positioned inside the receptacle 140.

The battery pack replacement system control module 117 may be configured to determine that a depleted battery pack 28 remains positioned in the receptacle 40 after generation of a control command directing the receptacle latching mechanism(s) 46 to actuate to unlatched configuration(s). The battery pack replacement system control module 117 may also be configured to generate an alert indicating that the depleted battery pack 28 remains positioned in the receptacle 40.

The battery pack replacement system control module 117 may also be configured to control operation of the replacement pack coupling system 48 to deploy a hook 48a of the coupling system to an active configuration for connecting the replacement pack 24 to the vehicle 21, responsive to an indication from a sensor that a battery pack has been released from the battery pack receptacle 40.

The processor(s) 110, the autonomous driving module 160, the battery pack replacement system control module 117 and/or other modules described herein can be operably connected to communicate with each other and with the other elements of the vehicle, including various vehicle systems and/or individual components thereof. For example, referring to FIG. 1. the processor(s) 110 and the autonomous driving module(s) 160 can be in communication to send and/or receive information from the various vehicle systems and sensors to control the movement, speed, maneuvering, heading, direction, etc. of the vehicle 21. For example, the processor(s) and/or the autonomous driving module(s) 160 can cause the vehicle 21 to accelerate (e.g., by increasing the supply of fuel provided to the engine), decelerate (e.g., by decreasing the supply of fuel to the engine and/or by applying brakes) and/or change direction (e.g., by turning the front two wheels). The processor(s) 110, the autonomous driving module(s) 160, the battery pack replacement system control module 117 and/or other elements of the vehicle may control some or all of the vehicle systems and, thus, may be partially or fully autonomous.

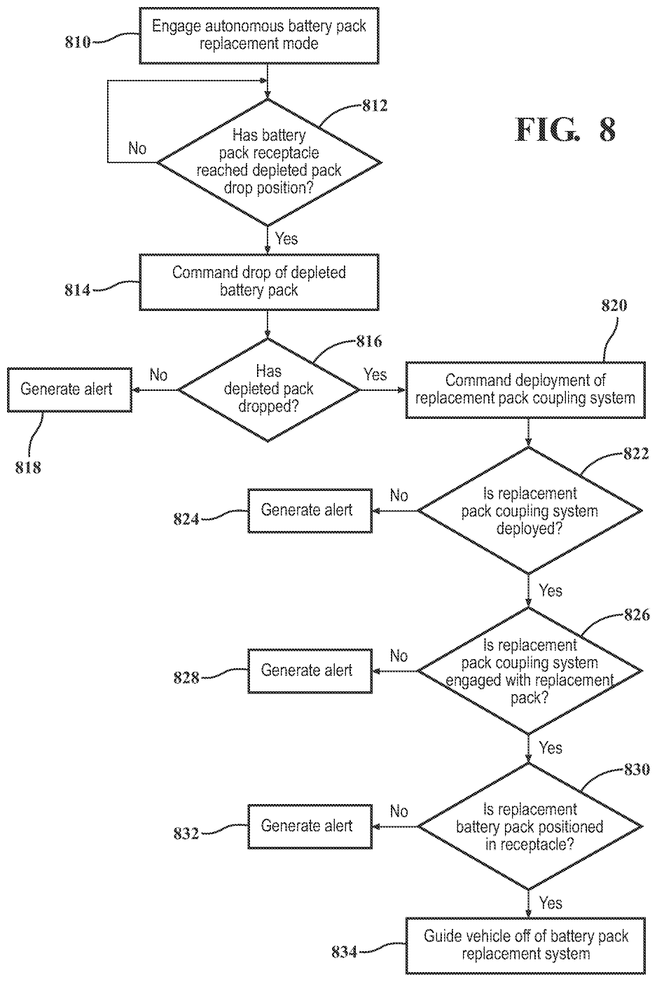

FIGS. 3-6 are schematic side views similar to the view shown in FIG. 2A, showing operation of an exemplary embodiment of the battery pack replacement system 20. FIG. 8 is a flow diagram describing replacement of a battery pack using the system 20. The autonomous driving module(s) 160 and the battery pack replacement system control module 117 may cooperate to control the vehicle 21 to autonomously drive the vehicle 21 along the battery pack replacement system 20 and replace a depleted battery pack 28.

Referring to FIG. 2, to initiate autonomous replacement of the battery pack 28, the driver may position the vehicle front wheels adjacent first ends 33a, 33b of the tracks 34a, 34b or on the first ends 33a, 33b of the tracks. The driver may then (in block 810, FIG. 8) engage an autonomous battery pack replacement mode of the vehicle. This may cause power for the vehicle 21 to be drawn from the secondary battery pack 126 instead of from the depleted battery pack 28 which is to be replaced. Movement of the vehicle 21 may be powered entirely by the secondary battery pack 126 during the process of replacing depleted pack 28 with replacement pack 24. Vehicle sensors (e.g., camera(s) and/or other sensors) may detect the tracks 34a, 34b and other features of the vehicle environment as well as the status of battery replacement operations as described herein.

The vehicle 21 may then autonomously move up the ramps 37a, 37b (“Position A” in FIG. 2A) at a relatively slow, constant speed toward leveled track portions 35a, 35b. The vehicle 21 may continue to move along leveled track portions 35a. 35b in direction D2 toward a position (“Position B”) where the depleted battery pack 28 is to be dropped onto the depleted battery pack discharge portion 26. The vehicle 21 may be constantly moving in the general direction D2 during the entire battery pack replacement process.

When pack-discharge position sensor 124 and/or battery pack replacement system control module 117 determine (in block 812) that the vehicle 21 has reached “Position B” where the depleted battery pack 28 is to be dropped onto the depleted battery pack discharge portion 26, the replacement system control module 117 may (in block 814) generate a command to actuate the receptacle latch(es) to respective unlatched conditions, to release the depleted battery pack 28 from the receptacle 40 onto the depleted battery pack discharge portion 26.

Battery pack replacement system control module 117 may then (in block 816) determine if the depleted battery pack 28 has exited the receptacle 40. If the depleted battery pack 28 has not exited the receptacle 40, battery pack replacement system control module 117 may (in block 818) generate an alert directed to informing the driver (or another person or entity) that the depleted battery pack 28 has not exited the receptacle 40. However, if it is determined that the depleted battery pack 28 has exited the receptacle 40, battery pack replacement system control module 117 may (in block 820) generate a control command to the replacement pack coupling system 48 to deploy a mechanism (such as hook 48a) to engage the replacement battery pack 24 to pull the replacement battery pack 24 up the replacement pack ramp 22.

Battery pack replacement system control module 117 may then (in block 822, using sensor data) determine if the replacement pack coupling system 48 has been deployed responsive to the deployment command. If the replacement pack coupling system 48 has not deployed, battery pack replacement system control module 117 may (in block 824 generate an alert directed to informing the driver (or another person or entity) that the replacement pack coupling system 48 has not been deployed. However, if the replacement pack coupling system 48 has deployed properly, the hook 48a will (as seen in FIG. 3) engage the complementary engagement feature 24a on the replacement battery pack 24 as the vehicle 21 continues to move in direction D2.

After deployment of the replacement pack coupling system hook 48a, the replacement system control module 117 may monitor the coupling system engagement sensor 123 to ensure that the hook 48a has properly engaged the replacement battery pack 24. If the coupling system engagement sensor 123 does not indicate (e.g., by detection of a sufficient pulling force on the hook 48a) that the hook 48a is pulling the replacement battery pack 24 up the ramp 22 by the time vehicle 21 travels a predetermined distance after deployment of the hook 48a, the replacement system control module 117 may determine (in block 826) that the coupling system 48 did not engage the replacement battery pack 24. The replacement system control module 117 may then (in block 828) generate an alert to this effect. However, if the coupling system engagement sensor 123 indicates that the hook 48a is pulling the replacement battery pack 24 up the ramp 22, the vehicle 21 may continue to move forward in direction D2.

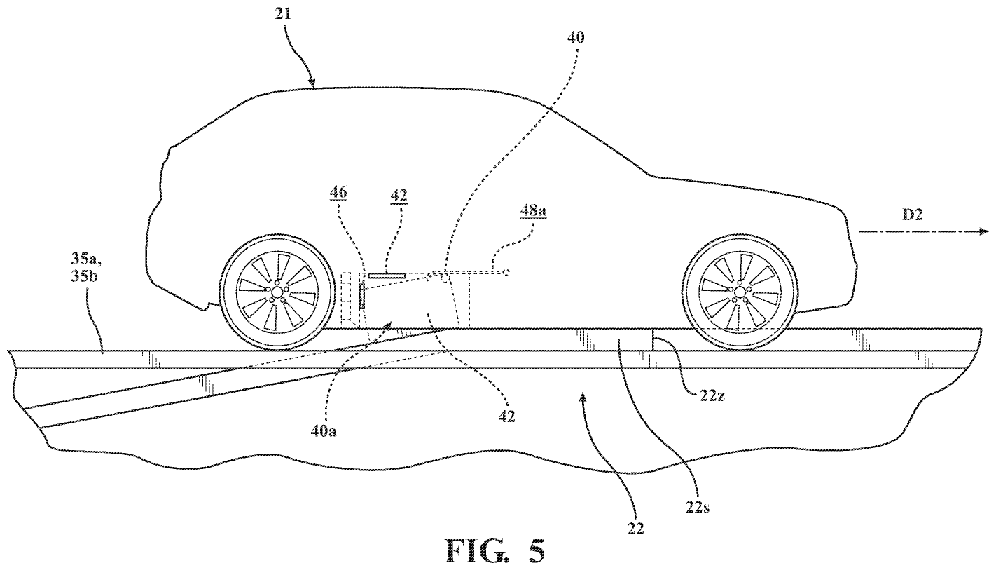

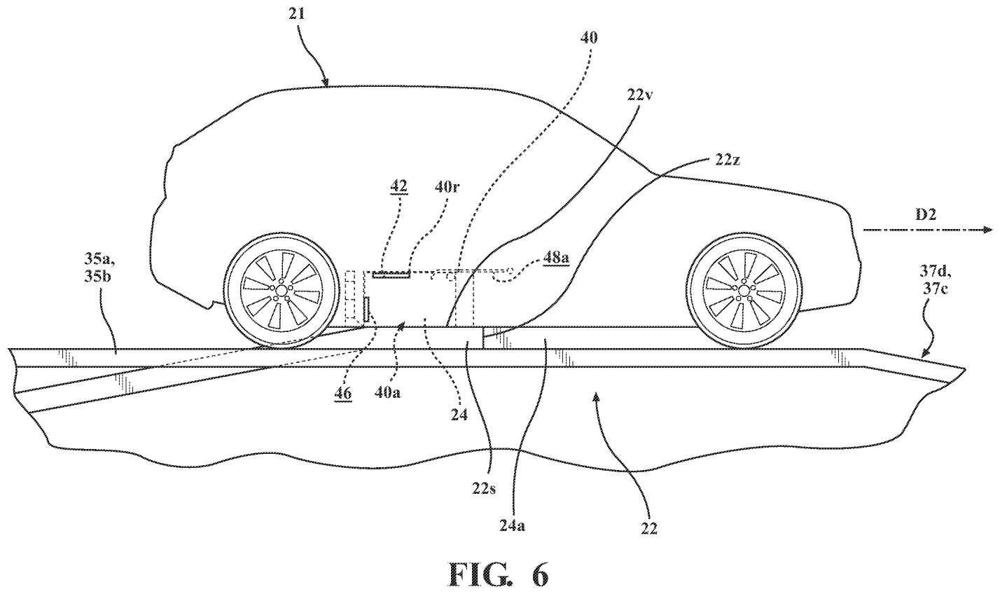

Referring to FIG. 4, as the vehicle continues to move further forward in direction D2, the replacement battery pack is pulled up the replacement pack ramp 22 toward the receptacle 40 and into the receptacle. Referring to FIG. 5, as the vehicle continues to move further forward in direction D2, the replacement battery pack 24 reaches the replacement pack ramp second end 22s. Referring to FIGS. 5 and 6, the height of the replacement pack ramp second end 22s may be specified in relation to the height of the receptacle 40 so that the replacement battery pack 24 is forced completely into the receptacle 40 as the pack 24 is pulled along the replacement pack ramp second end 22s. The replacement pack ramp second end 22s may be the highest portion of the replacement pack ramp 22 when the ramp is mounted in the battery pack replacement system 20 as shown in 2A to enable the vehicle 21 to drive over the ramp 22. In particular arrangements, an upper surface 22v (FIG. 6) of the replacement pack ramp second end 22s may be provided with a layer of a resiliently deformable material (such as a rubber) designed to enable the replacement battery pack 24 to be pressed firmly into the receptacle 40 against a roof 40r of the receptacle by the height of the replacement pack ramp second end 22s and resilient compression of the deformable material along the ramp second end. This may help ensure proper positioning of the replacement battery pack 24 in the receptacle 40.

Sensors of the sensor system 120 may monitor when the replacement battery pack 24 has entered the receptacle 40. In particular arrangements, pressing the replacement battery pack 24 into its end-use position in the receptacle 40 may cause the latching mechanism(s) 46 to automatically actuate to latched conditions, there by securing the replacement battery pack 24 in the receptacle. Pressing the replacement battery pack 24 into its end-use position in the receptacle 40 may also cause the battery pack power contacts 42 to electrically engage complementary contact on the battery pack 24 so as to enable power transfer from the replacement battery pack 24 to the vehicle 21.

FIG. 6 shows the replacement battery pack 24 positioned in the receptacle by movement of the battery pack 24 over the replacement pack ramp second end 22s. As the vehicle continues to move further forward in direction D2, the battery pack replacement system control module 117 may (in block 830) determine if the replacement battery pack 24 is positioned in the receptacle. For example, in one or more arrangements, based on information received from battery pack receptacle status sensors 121, the battery pack replacement system control module 117 may be configured to determine that, if there is no battery pack positioned in the receptacle 40 or if the receptacle latching mechanism(s) 44 are not engaged to secure a battery pack in the receptacle 40 and/or no power is being drawn from a battery pack residing in the receptacle, the replacement battery pack is not positioned in the receptacle 40. Other criteria may also (or alternatively) be used to determine if a replacement battery pack 24 is positioned in the receptacle. If it is determined that a replacement battery pack 24 is not positioned in the receptacle, the replacement system control module 117 may (in block 832) generate an alert to this effect.

If it is determined that a replacement battery pack 24 is positioned in the receptacle and that power is available from the replacement battery pack 24 to power the vehicle 21, the replacement system control module 117 may generate a command to discontinue drawing power from the secondary battery pack 126. The replacement system control module 117 may also (in block 824) control operation of the vehicle 21 to drive the vehicle off of the battery pack replacement system 20. The hook 48a and hook retention mechanism 48b may be structured so that, when the replacement battery pack 24 becomes positioned in the receptacle 40, the hook 40a has entered into the hook retention mechanism 48b and has become releasably secured in the hook retention mechanism 48b. The hook 48a remains secured in the hook retention mechanism 48b until released again as previously described for the purpose of engaging another replacement battery pack.

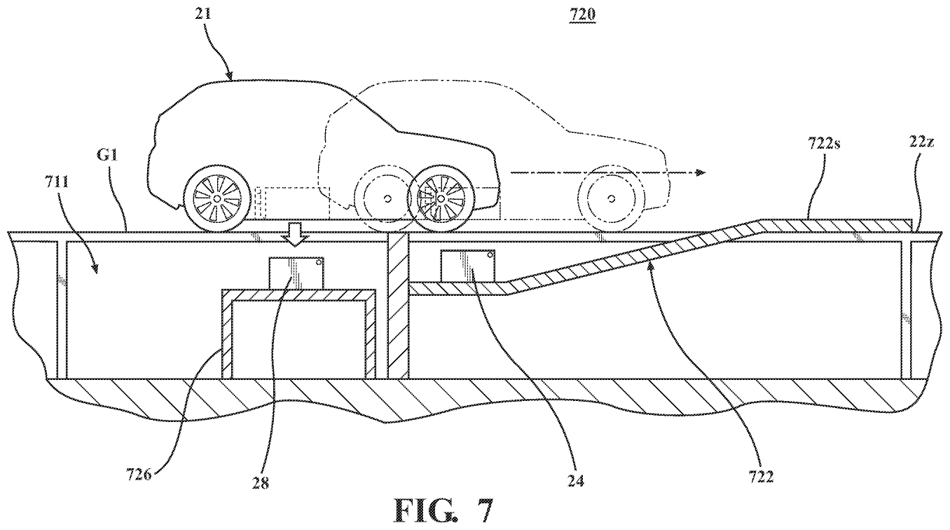

Referring now to FIG. 7, in an alternative arrangement 720 of the battery pack replacement system, the vehicle 21 may travel along the ground surface G1 and the replacement pack ramp 722 may be positioned in a cavity or pit 711 formed in the ground surface below a projected path of the vehicle 21 along the battery pack replacement system. The replacement pack ramp 722 may be structured and positioned so that the replacement pack ramp second end 722s extends above the ground surface G1 in a manner similar to that in which the replacement pack ramp second end 22s extends above the leveled portions 35a, 35b of the tracks 34a, 34b of the system 20 previously described.

The battery pack replacement system 720 may operate in the same manner as the system 20 previously described. Starting with engagement of an autonomous battery pack replacement mode configured to control movement of the vehicle 21 over a depleted battery pack discharge portion (generally designated 726) also located in the cavity 711 below ground surface G1. The vehicle 21 may then proceed autonomously over the replacement pack ramp 722 as previously described, discharging the depleted pack 28 onto the battery pack discharge portion 726, deploying the replacement pack coupling system 48 to couple the vehicle 21 to the replacement battery pack 24, and driving along the ground surface G1 over the replacement pack ramp 722 to engage the replacement pack 24 and pull the pack 24 up the ramp 722 onto replacement pack ramp second end 722s and into the battery pack receptacle 40. The embodiment of FIG. 7 is different mainly in that the structure supporting the vehicle 21 above the ground surface G1 is not needed because elements of the system requiring elevation of the vehicle 21 are positioned in the cavity 711.

From the above description, it may be seen that loading of the replacement battery pack 24 is performed autonomously, purely as a result of movement of the vehicle 21 along the vehicle support structure 34, and with no assistance from any powered mechanism urging the replacement battery pack 24 into the vehicle 21. As stated previously, movement of the vehicle 21 along the vehicle support structure 34 may be powered entirely by the secondary battery pack 126 during the battery pack replacement process, thereby allowing the depleted pack 28 to be electrically de-coupled from the vehicle 21 for replacement and the replacement pack 24 to be positioned in the vehicle 21 and electrically coupled to the vehicle.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module, as envisioned by the present disclosure, is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An electric vehicle (EV) battery pack replacement system, comprising:
a replacement pack ramp;
a vehicle-mountable battery pack receptacle; and
a vehicle-mountable replacement pack coupling system structured to be operable to connect a vehicle to a replacement pack positioned on the ramp during movement of the vehicle over the ramp, so that further movement of the vehicle over the ramp after connection to the replacement pack moves the replacement pack up the ramp, the ramp being structured so that movement of the replacement pack up the ramp causes the replacement pack to be positioned in in the receptacle.

2. The system of claim 1, wherein the ramp comprises:
a frame; and
a plurality of rolling elements supported by the frame so as to define a movement plane having a first slope.

3. The system of claim 1, further comprising a vehicle support structure having a first track extending along a first side of the ramp, and a second track extending along a second side of the ramp opposite the first side and parallel to the first track.

4. The system of claim 1, further comprising a depleted battery pack discharge portion structured to receive a depleted battery pack released from the pack receptacle and positioned spaced apart from the replacement pack ramp in a direction opposite a direction of travel of the vehicle from the battery pack discharge portion toward the replacement pack ramp.

5. The system of claim 4, wherein the depleted battery pack discharge portion includes a discharge ramp structured to slope downwardly from a location where the depleted battery pack is received from the vehicle.

6. The system of claim 3, wherein the replacement pack ramp has a first end and a second end, and wherein the ramp second end is positioned above a level of the first and second tracks.

7. The system of claim 6, wherein the first track includes a first leveled portion extending along the first side of the replacement pack ramp and adjacent the ramp second end, the second track includes a second leveled portion extending along the second side of the replacement pack ramp and adjacent the ramp second end, and wherein the first leveled portion and the second leveled portion are positioned at the same level.

8. The system of claim 7, wherein the first track includes a first vehicle ramp structured to be connectible to the first leveled portion, and the second track includes a second vehicle ramp structured to be connectible to the first leveled portion and positionable opposite the first vehicle ramp.

9. The system of claim 1, further comprising:
one or more processors; and
a memory communicably coupled to the one or more processors and storing a battery pack replacement system control module including computer-readable instructions that when executed by the one or more processors cause the one or more processors to:
determine that at least one latching mechanism is in one of an unlatched configuration and a latched configuration when it should be in the other of the unlatched configuration and the latched configuration; and
generate an alert indicating that the at least one latching mechanism is in an incorrect configuration.

10. The system of claim 1, wherein the pack receptacle includes at least one latching mechanism actuatable between a latched configuration structured to engage the replacement pack when the replacement pack is positioned inside the receptacle to secure the replacement pack inside the receptacle, and an unlatched configuration disengaged from the replacement pack, to enable the replacement pack to drop out of the receptacle.

11. The system of claim 1, further comprising:
one or more processors; and
a memory communicably coupled to the one or more processors and storing a pack replacement system control module including computer-readable instructions that when executed by the one or more processors cause the one or more processors to:
generate a control signal directing at least one latching mechanism to actuate to an unlatched configuration responsive to an indication from a sensor that the vehicle is in a position suitable for releasing a depleted battery pack from the receptacle; and
generate a control signal directing the at least one latching mechanism to actuate to a latched configuration responsive to an indication from a sensor that the replacement pack has been positioned inside the receptacle.

12. The system of claim 11, wherein the pack replacement system control module further includes computer-readable instructions that when executed by the one or more processors cause the one or more processors to:
determine that a depleted battery pack remains positioned in the receptacle after generation of a control command directing at least one latching mechanism to actuate to the unlatched configuration; and
generate an alert indicating that the depleted battery pack remains positioned in the receptacle.

13. The system of claim 1 wherein the pack receptacle includes at least one battery power contact structured to physically contact a complementary contact positioned on the replacement pack, to enable power transfer from the replacement pack to the vehicle when the replacement pack is positioned inside the receptacle.

14. The system of claim 1, wherein the replacement pack coupling system comprises:
a hook structured to engage a complementary feature on the replacement pack to connect the vehicle to the replacement pack; and
a hook retention mechanism structured to be actuatable to deploy the hook to an active configuration for connecting the replacement pack to the vehicle, and to secure the hook in an inactive configuration when not in use.

15. The system of claim 14, further comprising a vehicle-mountable sensor configured to determine if the replacement battery pack coupling system is engaged with the replacement pack.

16. The system of claim 1, further comprising:
one or more processors; and
a memory communicably coupled to the one or more processors and storing a pack replacement system control module including computer-readable instructions that when executed by the one or more processors cause the one or more processors to:
control operation of the replacement pack coupling system to deploy a hook of the coupling system to an active configuration for connecting the replacement pack to the vehicle, responsive to an indication from a sensor that a battery pack has been released from the receptacle.

17. The system of claim 1, further comprising a vehicle-mountable sensor configured to determine when the vehicle is in a position suitable for releasing a depleted battery pack from the receptacle.

18. The system of claim 1, further comprising a vehicle-mountable sensor configured to detect when a replacement pack is positioned inside the receptacle.

19. The system of claim 1, further comprising a vehicle-mountable sensor configured to detect a latched configuration and/or an unlatched configuration of the at least one latching mechanism.

20. The system of claim 1 wherein the replacement pack ramp is mounted in a cavity formed in a ground surface along which the vehicle moves.
